(19) United States
(12) Patent Application Publication
(10) Pub. No.: US 2025/0389249 A1
(43) Pub. Date: Dec. 25, 2025

(54) PHYSICS-INCORPORATED TURBINE BLADE PITCH CONTROL TECHNOLOGY

(71) Applicant: University of Maryland, Baltimore County, Baltimore, MD (US)

(72) Inventors: Meilin YU, Ellicott City, MD (US); Kai S. Wisner, Syracuse, NY (US)

(21) Appl. No.: 18/640,898

(22) Filed: Apr. 19, 2024

Related U.S. Application Data
(60) Provisional application No. 63/497,296, filed on Apr. 20, 2023.

(51) Int. Cl. F03D 3/00; F03D 7/06

(52) U.S. Cl. CPC F03D 3/011; F03D 7/06; F05B 2260/70; F05B 2270/32

(57) ABSTRACT

A novel blade pitch control technology for straight-bladed vertical-axis turbines for wind/wave/tidal energy harvesting is described. Flow physics was incorporated in the control mechanism to maximize turbine performance, including self-starting and energy harvesting efficiency.

### CROSS REFERENCE TO RELATED APPLICATIONS

This application claims priority to U.S. Provisional Patent Application No. 63/497,296 filed on Apr. 20, 2023 in the name of Meilin Y U and Kai S. WISNER entitled “PHYSICS-INCORPORATED TURBINE BLADE PITCH CONTROL TECHNOLOGY,” which is hereby incorporated by reference herein in its entirety.

### FIELD

The present invention relates to improved blade pitch control technology that to enhance the energy outputs of vertical axis turbines (VATs).

### BACKGROUND

Vertical-axis turbines (VATs) have great potential applications in renewable energy harvesting from wind and hydrokinetic flows such as tides, ocean currents, waves, and river flows. However, VATs have been underutilized in the renewable energy market compared to their horizontal-axis counterparts. One of the driving factors that prevent VATs from gaining popularity is their typically inferior energy harvesting performance, a result due to their intrinsically complex aero- or hydrodynamics, when compared to horizontal-axis turbines (HATs). However, when taking a fundamental look at the difference between VATs and HATs, the difference in real life performance is perplexing. Given two turbines that have the same frontal area, the same amount of energy will flow through both turbines. This means that both turbines have the potential to extract the same amount of energy if their efficiencies are comparable. When taking the analysis further, VATs interact with the flow for a longer period (i.e., upstream and downstream cycles) of time when compared to HATs, for example as shown in the illustration of a three-bladed VAT in FIG. 1A. This longer period of interaction with the fluid flow gives VATs the potential to extract more energy than HATs.

As has been recognized, one of the main reasons that contribute to the inferior performance of VATs, including poor self-starting capability and low efficiency, is that as the turbine rotates through the azimuth, the blades can stall at different locations for different reasons [A.-J. Buchner et al., 2015]. Once one of the blades stalls, the drag on that blade is significantly increased, which until the flow reattaches to the blade, will act to slow the rotation of the turbine. If a VAT has the capability to change the pitch of the blades based on the local flow conditions, a control mechanism can then be devised to mitigate the negative impact that a stalling blade would have on the energy production. However, just reducing the impact that a stall has on the performance of the turbine will not necessarily improve the turbine's performance. For airfoils, the angle of attack (AoA) and its rate of change have a dramatic effect on the magnitude of the lift and drag forces. Unfortunately, because the VAT is constantly rotating, resulting in a constantly changing flow condition, the blade performance can hardly be optimized without adjusting its installation angle, the angle between the chord line of the foil and the tangential direction of the blade trajectory [B. Kirke et al., 2011]. FIG. 1B illustrates typical AoA variations of one blade during one rotation cycle for a VAT with a constant angular velocity under different tip speed ratio (TSR) conditions. Dynamic stall, which occurs when the AoA induced by the motion of a foil exceeds its static stall AoA and can transiently boost unsteady lift generation, can easily show up over a VAT blade at low TSRs, while gets suppressed at high TSRs.

Different blade pitch control approaches for VATs have been explored for almost half a century. In general, the pitch control technique can be categorized into passive and active control groups. The primary goal of some prior art passive control technologies is to prevent the blades from stalling, especially during the starting stage. Unfortunately, the passive control systems are likely not adaptable to changing electrical loads, wind conditions, and parasitic loads.

There are many different active (forced) pitch control approaches for VATs. The earliest and simplest approaches are to statically change the relative angle for the upstream and downstream cycle separately (G. Abdalrahman et al, 2017; L. Li et al., 2021). This has some benefits to reduce the AoA and to reduce the severity of the stall. Given the complexity and limitations of the involved mechanical system, the performance increase over a fixed pitch turbine is limited. The next level in pitch control complexity is sinusoidal AoA control. This type of control typically modifies the angle of the blades relative to the tangential position of the blades in a sinusoidal manner and can offer some benefits such as reducing AoA to prevent the blades from stalling. Another type of blade pitch control is the so-called second-order harmonic pitch control, which aims to increase the amount of time per rotation that a blade is positioned such that it is able to generate the greatest ratio between lift and drag. However, such types of control methods usually use Fourier series to drive the control, which can cause undesired fluctuations. Additionally, turbines are subjected to a wide variety of changing conditions which means that the pitch controller must be able to react to them. A Fourier series controller that is capable of handling changing flow conditions would be extremely complex.

Several research groups have taken a completely different approach where instead of defining the pitch profile, the approach aims to optimize the pitch function (C. Li et al., 2018; I. Paraschivoiu et al., 2009; D. De Tavernier et al., 2019). There, the pitch control was adjusted based on the performance of the previous control scheme. As a result, significant performance improvements can be obtained compared to the pitch control with a fixed pitch profile. However, the fundamental challenge of this approach is that the pitch profile optimization depends on specific flow conditions and turbine structures. An implementation of the optimized pitch function would likely result in a rigid controller that would struggle to react to conditions that are outside those used in the optimization.

Some other researchers have looked at increasing the performance of VATs through the use of adaptive blades, which can also be treated as a special blade pitch control mechanism through blade deformation or blade shape modification. Wang et al. [Y. Wang et al., 2016] theorized that using a blade that would be capable of deforming could increase the blade's aerodynamic performance. The authors summarized that the deforming blades with reduced AoAs offer some performance improvement when the TSR is below the optimal value when compared directly to a turbine with rigid blades. Moreover, many researchers have explored VAT performance enhancement using different airfoil profiles. Zhao et al. [Z. Zhao et al., 2022] articulated that despite the vast amount of research dedicated to different airfoil types, there is no consensus on the optimal blade profile. Another airfoil design is the helical blade. The theory behind helical blades is that since the blades are twisted radially around the turbine's axis of rotation, an airfoil section is at every possible azimuth angle. This acts to smooth out the torque fluctuations as the turbine rotates but does not necessarily enhance the turbine efficiency.

There are many other VAT control concepts that are not directly related to pitch control, such as active modification of solidity, local flow control over blades, and turbine configuration modifications. However, it is noted that most, if not all, of the performance improvements through these approaches can be achieved through certain blade pitch control. An additional note is that compared to passive flow control methods, the active blade pitch control (and other active control methods) requires energy input. However, as will be explained in Sect. 1A (i) hereinbelow and demonstrated in the present inventors' previous study [K. S. Wisner, 2023], the actuator power consumption for carefully designed pitch control is usually smaller than 5% of the total energy harvested. As a result, the overall energy harvesting efficiency of the VAT can achieve high values over 50%. This is comparable to or exceeds the best performance reported in the aforementioned literature with various VAT control methods.

There continues to be a need for improved blade pitch control technology that provides a viable solution to maximize energy outputs of VATs.

### SUMMARY

In one aspect, a method of enhancing the performance of a vertical axis turbine (VAT) comprising at least two turbine blades is described, said method comprising:
integrating blade pitch control with the VAT, wherein blade pitch for each blade is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric).

In another aspect, a vertical axis turbine (VAT) is described comprising:
at least two turbine blades;
at least two actuators, wherein each turbine blade has a dedicated actuator and wherein a blade pitch of each blade is independently adjustable by the dedicated actuator;
a shaft, wherein the at least two turbine blades are arranged to rotate about the shaft;
a base or pedestal to support the shaft;
an anemometer; and
a computer program product communicatively connected to each actuator and the anemometer, wherein the computer program product comprises a computer readable storage medium having program instructions embodied therewith, the program instructions executable by a computing device to cause the computing device to control the VAT to enhance the performance of the VAT by:
   integrating blade pitch control with the VAT, wherein blade pitch is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric), wherein the blade pitch of each blade is continuously adjusted using the actuators.

In still another aspect, a computer program product comprising a computer readable storage medium having program instructions embodied therewith is described, the program instructions executable by a computing device to cause the computing device to control a vertical axis turbine (VAT) comprising at least two turbine blades to enhance the performance of the VAT by:

integrating blade pitch control with the VAT, wherein blade pitch is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric), wherein the blade pitch is continuously adjusted using actuators.

Other aspects, features and embodiments of the invention will be more fully apparent from the ensuing disclosure and appended claims.

### BRIEF DESCRIPTION OF THE FIGURES

FIG. 1A. A top view of a three-bladed Darrieus-type VAT, and the definition of upstream and downstream cycles, wherein the line drawn through the circle perpendicular to the fluid velocity vector defines the switch from upstream to downstream, and the corresponding azimuthal angle.

FIG. 1B. The AoA variations of one blade during one rotation cycle for a VAT without pitch control at different TSRs.

FIG. 2. Illustration of the geometric relationships between different velocities, AoA, pitch angle, and azimuth angle of one VAT blade before (dashed airfoil) and after (solid airfoil) pitch.

FIG. 3. The AoA from a sinusoidal AoA control compared to the AoA without control with respect to the azimuth angle at TSR=2. The amplitude of the pitch angle is π/14 (i.e., 12.86°).

FIG. 4A. The AoA of the symmetric AoA functions compared to the AoA without control with respect to the azimuth angle at TSR=2.

FIG. 4B the corresponding pitch angle functions that were used to produce the different symmetric AoA functions.

FIG. 5. The AoA of the asymmetric AoA functions compared to the AoA without control with respect to the azimuth angle at TSR=2.

FIG. 6A. An overview of the mesh used in simulations.

FIG. 6B. Meshes near three turbine blades and the regions with sliding meshes are colored in red, green and blue.

FIG. 6C. An enlarged view of meshes around a specific blade with the pivot point located at the aerodynamic center.

FIG. 7. Comparison of time-averaged net (or effective) power coefficients with respect to TSR across wind speeds from the baseline cases without control and those from the cases with the best control performance. Herein, ‘NP’ indicates the baseline cases without blade pitch control, and ‘VP’ indicates the cases with variable blade pitch control, either using symmetric or asymmetric AoA control functions. As documented in Table 3, the best control performance for all wind speeds (except 14 m/s) at TSR=1.5, 2 and 2.25 is achieved with asymmetric AoA control, and that at TSR=2.5 and 3 is achieved with symmetric AoA control.

FIG. 8A. Phase-averaged torque coefficient of the turbine blade for a turbine without blade pitch control at different TSRs when wind speed is 3.5 m/s.

FIG. 8B. Phase-averaged torque coefficient of the turbine blade for a turbine without blade pitch control at different TSRs when wind speed is 7 m/s.

FIG. 8C. Phase-averaged torque coefficient of the turbine blade for a turbine without blade pitch control at different TSRs when wind speed is 14 m/s.

FIG. 9A. Typical instantaneous vorticity fields for baseline cases without control. TSR=1.5, wind speed (WS)=3.5 m/s. Vorticity scale shown in FIG. 9D.

FIG. 9B. Typical instantaneous vorticity fields for baseline cases without control. TSR=1.5, WS=3.5 m/s. Vorticity scale shown in FIG. 9D.

FIG. 9C. Typical instantaneous vorticity fields for baseline cases without control. TSR=2.25, WS=7 m/s. Vorticity scale shown in FIG. 9D.

FIG. 9D. Typical instantaneous vorticity fields for baseline cases without control. TSR=2.25, WS=7 m/s, and vorticity scale.

FIG. 9E. Typical instantaneous vorticity fields for baseline cases without control. TSR=3, WS=14 m/s. Vorticity scale shown in FIG. 9D.

FIG. 9F. Typical instantaneous vorticity fields for baseline cases without control. TSR=3, WS=14 m/s. Vorticity scale shown in FIG. 9D.

FIG. 10A. Comparison of the phase-averaged torque coefficient of the turbine blade for a turbine with sinusoidal AoA control and that without blade pitch control. The pitch amplitude is π/14 (i.e., 12.86°) at TSR=2 and WS=3.5 m/s. Herein, ‘NC’ indicates the baseline cases without blade pitch control, and ‘VP’ indicates the cases with variable blade pitch control.

FIG. 10B. Comparison of the phase-averaged torque coefficient of the turbine blade for a turbine with sinusoidal AoA control and that without blade pitch control. The pitch amplitude is π/9 (i.e., 20°) at TSR=2 and WS=7 m/s.

FIG. 11A. Typical instantaneous vorticity fields for the cases with sinusoidal AoA control. TSR=2, WS=3.5 m/s. Vorticity scale shown in FIG. 9D.

FIG. 11B. Typical instantaneous vorticity fields for the cases with sinusoidal AoA control. TSR=2, WS=3.5 m/s. Vorticity scale shown in FIG. 9D.

FIG. 11C. Typical instantaneous vorticity fields for the cases with sinusoidal AoA control. TSR=2, WS=7 m/s. Vorticity scale shown in FIG. 9D.

FIG. 11D. Typical instantaneous vorticity fields for the cases with sinusoidal AoA control. TSR=2, WS=7 m/s. Vorticity scale shown in FIG. 9D.

FIG. 12A. Comparison of the phase-averaged torque coefficient of the turbine blade for a turbine with constant AoA control and that without blade pitch control. The symmetric constant AoA control with an AoA of 15.03° at TSR=2.25 and WS=14 m/s.

FIG. 12B. Comparison of the phase-averaged torque coefficient of the turbine blade for a turbine with constant AoA control and that without blade pitch control. The asymmetric constant AoA control with AoAs of 15.03° (upstream) and 17.53° (downstream) at TSR=2 and WS=14 m/s.

FIG. 13A. Typical instantaneous vorticity fields for the case with asymmetric AoA control using AoA=15.03° (upstream) and 17.53° (downstream) at TSR=2 and WS=14 m/s. Vorticity scale shown in FIG. 9D.

FIG. 13B. Typical instantaneous vorticity fields for the case with asymmetric AoA control using AoA=15.03° (upstream) and 17.53° (downstream) at TSR=2 and WS=14 m/s. Vorticity scale shown in FIG. 9D.

FIG. 14. Comparison of the phase-averaged torque coefficient of the turbine blade for a turbine with variable control methods and that without blade pitch control at TSR=2 and WS=7 m/s.

FIG. 15A. Typical instantaneous vorticity fields for several cases with blade pitch control at TSR=2 and WS=7 m/s. Symmetric AoA control with AoA=9.55°.

FIG. 15B. Typical instantaneous vorticity fields for several cases with blade pitch control at TSR=2 and WS=7 m/s. Symmetric AoA control with AoA=9.55°.

FIG. 15C. Typical instantaneous vorticity fields for several cases with blade pitch control at TSR=2 and WS=7 m/s. Symmetric AoA control with AoA=20.1°.

FIG. 15D. Typical instantaneous vorticity fields for several cases with blade pitch control at TSR=2 and WS=7 m/s. Symmetric AoA control with AoA=20.1°.

FIG. 15E. Typical instantaneous vorticity fields for several cases with blade pitch control at TSR=2 and WS=7 m/s. Asymmetric AoA control with AoA=15.1° (upstream) and 25.1° (downstream).

FIG. 15F. Typical instantaneous vorticity fields for several cases with blade pitch control at TSR=2 and WS=7 m/s. Asymmetric AoA control with AoA=15.1° (upstream) and 25.1° (downstream).

FIG. 16. Phase-dependent power coefficients across wind speeds for the cases with the best control performance.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As defined herein, a “body of water” includes, but is not limited to, a bay, a bayou, a canal, a channel, a cove, a creek, a delta, an estuary, a fjord, a gulf, a harbor, an inlet, a lake, a mill pond, an ocean, a pond, a reservoir, a river, a sea, a sound, a strait, a stream, and a tide.

As used herein, a “fluid” can be wind or water.

As well-known in the art, “tip speed ratio” or “TSR” is defined as the ratio between the rotating speed at the tip of the rotor and the incoming fluid speed. As defined herein, a “low TSR” is less than or equal to about 2, a “medium TSR” is between about 2 to about 5, and a “high TSR” is greater than or equal to about 5.

As defined herein, the “self-starting” capability of a VAT is defined as that the fluid turbine can reach the desirable TSRs under nominal fluid flow conditions without external load. As a result, the turbines can effectively harvest fluid energy when appropriate energy collectors (in the form of external load) are activated.

As used herein, the “angle of attack” is the angle in degrees between the relative velocity vector of the airfoil with respect to the wind direction or water flowing direction and the chord line of the airfoil.

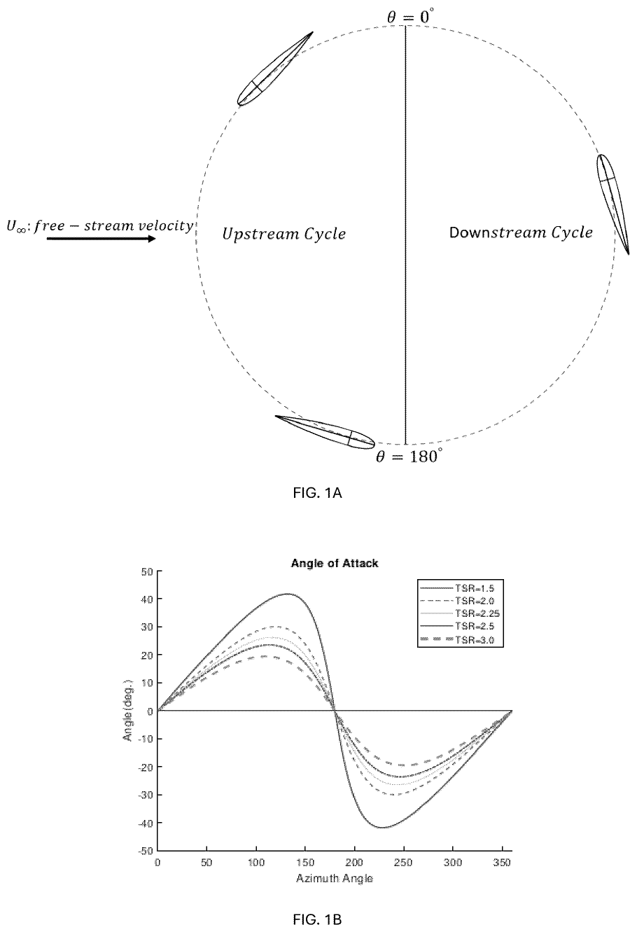

As used herein, the “azimuthal angle” is the angular position, in degrees and in the counter clockwise direction, of an individual blade of the VAT. Referring to FIG. 1A, 0° is the transition point between the end of the downstream cycle and the beginning of the upstream cycle. As understood to the person skilled in the art, the imaginary line connecting 0° and 180° is perpendicular to the incoming free-stream velocity (for example, of wind or water), and as such, the location of 0° and 180° changes with a change in direction of the free-stream velocity. Accordingly, the “upstream cycle” is any azimuth angle from 0 to 180 degrees and the “downstream cycle” is from 180 to 360 degrees. In some embodiments, the “upstream cycle” is any azimuth angle from 0 (+/−10 degrees) to 180 degrees (+/−10 degrees) and the “downstream cycle” is from 180 (+/−10 degrees) to 360 degrees (+/−10 degrees).

Traditionally, VATs can be classified into two dominant types, namely, Darrieus and Savonius type turbines. The Darrieus VAT is a lift-driven fluid turbine, and usually has high energy harvesting efficiency at relatively large tip speed ratios (TSRs). Darrieus VATs are known to suffer from self-starting issues due to the dead band of negative torque at small TSRs. The Savonius VAT falls into the category of drag-driven fluid turbines. It is self-starting and works well at small TSRs. Previously, a hybrid VAT comprising a modified-Savonius (MS) rotor in the central region and a straight bladed H-type Darrieus rotor in the surrounding annular region, or a hybrid Darrieus-Modified-Savonius (HDMS) VAT, was described in U.S. Pat. No. 11,313,348 in the name of Meilin Yu et al., which is hereby incorporated herein in its entirety. Savonius rotors can comprise cups, can be aerofoil-shaped, or can be helical, curved or straight. Darrieus rotors can have an egg-beater shape, a helical shape or an H-shape, as known to the person skilled in the art. VATs are constructed so that the turbine blades rotate around a common axis in either clockwise or anti-clockwise parity. In some embodiments, the common axis comprises a shaft. In some embodiments, the shaft can be static, with the blades mounted upon and rotating about the non-rotating shaft on bearings or bushings. In some embodiments, the shaft can be rotatable, wherein the blades are attached to the rotatable shaft, and the rotating shaft rotates about the central axis, as understood by the person skilled in the art. VAT can comprise a brake system, for example a hydraulic brake system, that is mounted upon the shaft with bearings to limit the rotational speed of the rotor assembly to a maximum speed at high fluid speeds, as readily determined by the person skilled in the art.

VATs are well known to have a cycloidal geometry and as such the VAT blade experiences a continuously oscillating AoA. To the inventors' knowledge, there are no teachings relating to the maintenance or control of the AoA at a constant angle as the VAT blade rotates around the shaft.

Broadly, this disclosure relates to cost-effective constant AoA controllers that can be implemented into hardware in a straightforward manner for VATs. Advantageously, the constant AoA controllers have the benefit of being a continuous function with a finite number of variables to facilitate practical implementation. Unlike the systems of the prior art, no Fourier series controller is needed. Advantageously, the constant AoA controllers using a continuous function are capable of reacting to a variety of flow conditions (e.g., wind, gusts, TSR, and load on the turbine) and can drastically improve the performance of VATs in a wide range of wind speeds. Moreover, the control scheme described herein is capable of capturing torque increases generated in the downstream cycle, for example during the asymmetric AoA control scheme, which increases the overall performance of the turbine.

In a first aspect, a method of enhancing the performance of a vertical axis turbine (VAT) comprising at least two turbine blades is described, said method comprising:
integrating blade pitch control with the VAT, wherein blade pitch for each blade is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric).
   In some embodiments, the second constant AoA is greater than the first constant AoA.

The AoA controllers described herein are capable of continuously changing the blade pitch simultaneously and independently based on the control scheme, e.g., using Eq. (3) herein or some other relationship known to those skilled in the art. In other words, if the VAT comprises three blades, the AoA controllers described herein are capable of continuously changing the three blade pitches simultaneously and independently based on the control scheme. In some embodiments, the blade pitch is changed or adjusted using actuators, wherein each blade comprises its own actuator. Advantageously, a blade pitch control system based on actuators provides more flexibility and robustness. The symmetric AoA and asymmetric AoA functions described herein are capable of changing the angular acceleration that is required to pitch the blades, which can be used to accommodate different actuator performances. In some embodiments, the actuator is chosen to produce the torque required to drive the accelerations seen in the controller. Accordingly, in some embodiments, the actuators chosen are specific to the design of the VAT, as understood by the person skilled in the art. For example, in some embodiments when the fluid is wind, the actuator is a fast-response actuator. In some embodiments when the fluid is water, the actuator is a waterproof, high-load actuator.

In some embodiments, a smart controller can be developed to use the AoA control scheme and adapt to changing wind conditions, resulting in a control profile that can be implemented into an AoA controller with the potential to learn and adapt to its environment. In some embodiments, the control scheme has the capabilities to be modified or self-modified which would allow a controller to optimize or enhance its performance in real time.

In some other embodiments, the AoA control function comprising a symmetric constant AoA control or an asymmetric constant AoA control further comprises a peak component, which is used to boost lift without inducing stall, or to shed a vortex that could interact with a blade in the downstream side of the turbine.

In some embodiments, when the AoA control function is either symmetric or asymmetric, there is an induction of a short-term dynamic stall at an azimuthal angle of about 350°. Without being bound by theory, it is believed that the rapid change in blade angle that occurs at this azimuth angle helps to briefly induce dynamic stall before the control reverses the pitch angle to begin to pitch the blade for the upstream AoA. In this scheme, the turbine can momentarily generate a large amount of life even though the AoA is above its stall AoA, i.e., “dynamic stall.”

In some embodiments, the VAT is a Darrieus VAT. In some embodiments, the Darrieus VAT comprises H-shaped turbine blades. In some embodiments, the Darrieus VAT comprises egg beater-shaped turbine blades. In some embodiments, the Darrieus VAT comprises helical-shaped turbine blades.

In some embodiments, the VAT comprises symmetric or asymmetric airfoils as turbine blades. In some embodiments, the VAT comprises symmetric airfoils as turbine blades. In some other embodiments, the VAT comprises asymmetric airfoils as turbine blades. In some embodiments, the airfoil used in the VAT is NACA0015. In some embodiments, the airfoil used in the VAT is NACA0012. In some embodiments, the airfoil used in the VAT is NACA0018. It should be appreciated by the person skilled in the art that the airfoils are not limited herein and the systems and methods described herein can be adapted to use any of the airfoils described in, for example, “airfoiltools dot com/search/airfoils?m=a” which is incorporated herein in its entirety.

In some embodiments, the VAT comprises 2 turbine blades. In some embodiments, the VAT comprises 3 turbine blades. In some embodiments, the VAT comprises 4 turbine blades. In some embodiments, the VAT comprises 5 turbine blades. In some embodiments, the VAT comprises 6 turbine blades.

In some embodiments, the chord length of the VAT turbine blades are in a range from about 0.05 m to about 10 m, for example about 0.05 m to about 0.1 m, about 0.1 m to about 0.2 m, about 0.2 m to about 0.3 m, about 0.3 m to about 0.4 m, about 0.4 m to about 0.5 m, about 0.5 m to about 0.6 m, about 0.6 m to about 0.7 m, about 0.7 m to about 0.8 m, about 0.8 m to about 0.9 m, about 0.9 m to about 1 m, about 1 m to about 2 m, about 2 m to about 3 m, about 3 m to about 4 m, about 4 m to about 5 m, about 5 m to about 6 m, about 6 m to about 7 m, about 7 m to about 8 m, about 8 m to about 9 m, about 9 m to about 10 m, or any combination thereof. It should be appreciated that the chord length could be less than about 0.05 m or more than about 1 m, depending on the VAT requirements. In some embodiments, the chord length of the VAT turbine blades is in a range from about 0.1 m to about 0.5 m.

In some embodiments, the “radius” of the VAT from a center shaft to the turbine blades is about 0.2 m to about 10 m, for example, about 0.2 m to about 0.5 m, about 0.4 m to about 0.8 m, about 0.5 m to about 1 m, about 1 m to about 2 m, about 2 m to about 3 m, about 3 m to about 4 m, about 4 m to about 5 m, about 5 m to about 6 m, about 6 m to about 7 m, about 7 m to about 8 m, about 8 m to about 9 m, about 9 m to about 10 m, or any combination thereof.

In some embodiments, the height of the VAT is about 0.1 m to about 20 m, for example, about 0.1 to about 0.5, about 0.5 m to about 1 m, about 1 m to about 2 m, about 2 m to about 3 m, about 3 m to about 4 m, about 4 m to about 5 m, about 5 m to about 10 m, about 10 m to about 15 m, about 15 m to about 20 m, or any combination thereof.

In some embodiments, the solidity of the VAT is about 0.1 to about 0.5, for example, about 0.1 to about 0.2, about 0.2 to about 0.3, about 0.3 to about 0.4, about 0.4 to about 0.5, about 0.4 to about 0.41, about 0.41 to about 0.42, about 0.42 to about 0.43, about 0.43 to about 0.44, about 0.44 to about 0.45, about 0.45 to about 0.46, about 0.46 to about 0.47, about 0.47 to about 0.48, about 0.48 to about 0.49, about 0.49 to about 0.50, or any combination thereof.

In some embodiments, the TSR is in a range from about 2.0 to about 2.5.

In some embodiments, the symmetric constant AoA is in a range from about 15° to about 18°, or in a range from about 15.03° to about 18.02°.

In some embodiments, the first constant AoA for the asymmetric control scheme is in a range from about 15° to about 18°, or from about 15° to about 17°, or from about 15° to about 16°, or from about 15° to about 15.5°, and the second constant AoA for the asymmetric control scheme is in a range from about 16° to about 20°, wherein the second constant AoA is greater than the first constant AoA.

In some embodiments, the enhanced performance corresponds to a power coefficient (C_{P}) of greater than 0.4, greater than 0.41, greater than 0.42, greater than 0.43, greater than 0.44, greater than 0.45, greater than 0.46, greater than 0.47, greater than 0.48, greater than 0.49, greater than 0.50, greater than 0.51, greater than 0.52, greater than 0.53, greater than 0.54, or greater than 0.55. In some embodiments, the enhanced performance corresponds to a power coefficient (C_{P}) of greater than 0.5.

The VAT described herein includes an anemometer, or equivalent thereof. The anemometer is communicatively connected to the system and computer program product so as to continuously adjust the transition point between the end of the downstream cycle and the beginning of the upstream cycle (0°) and the transition point between the end of the upstream cycle and the beginning of the down stream cycle (180°), thereby ensuring that the AoA control scheme (e.g., symmetric or asymmetric) maximizes the performance of the VAT.

In some embodiments, the VAT is a Darrieus VAT comprising symmetric airfoils as turbine blades, wherein the symmetric constant AoA is in a range from about 15° to about 18°, or in a range from about 15.03° to about 18.02°. In some embodiments, the VAT is a Darrieus VAT comprising symmetric airfoils as turbine blades, wherein the first constant AoA for the asymmetric control scheme is in a range from about 15° to about 18°, or from about 15° to about 17°, or from about 15° to about 16°, or from about 15° to about 15.5°, and the second constant AoA for the asymmetric control scheme is in a range from about 16° to about 20°, wherein the second constant AoA is greater than the first constant AoA.

It should be appreciated by the person skilled in the art that for each VAT design (i.e., including the blade used, the number of blades, the chord length, the radius, the height, and/or the solidity), the AoA will need to be determined for the symmetric AoA or the asymmetric AoAs (i.e., the first constant AoA for the upstream and the second constant AoA for the downstream), as readily understood by the person skilled in the art. For example, simulations can be performed as described herein to identify the AoAs, at various wind speeds and TSRs, that enhance or maximize performance of the VAT. In some embodiments, at least one symmetric AoA is identified. Using a preferred symmetric AoA as the upstream or first constant AoA, at least one downstream or second constant AoA can be identified for the asymmetric AoA constant scheme.

It should be appreciated that the improvements described herein, i.e., the constant AoA, can be combined with other active pitch control techniques known in the art to further improve the performance of the VAT.

Advantageously, flow driven controllers are better suited to adapt to changing environmental conditions, while also being able to respond to the dynamic behavior of the downstream cycle. This results in better performance/efficiency, as well as being able to ensure that the turbine will start at low wind speeds.

In some embodiments of the first aspect, a method of enhancing the performance of a vertical axis turbine (VAT) comprising at least two turbine blades is described, said method comprising:
integrating blade pitch control with the VAT, wherein blade pitch for each blade is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric),
wherein the blade pitch of each blade is continuously adjusted using actuators.
   In some embodiments, the second constant AoA is greater than the first constant AoA.

It should be appreciated by the person skilled in the art that the method of the first aspect requires the use of a computer program product to continuously maintain the constant AoA (whether symmetric or asymmetric) for each blade by adjusting the pitch of each blade, independently and continuously, for example, using actuators. In some embodiments, artificial intelligence is used to learn and adapt to its environment, thereby maximizing the performance of the VAT.

Accordingly, in a second aspect, a computer program product is described comprising a computer readable storage medium having program instructions embodied therewith, the program instructions executable by a computing device to cause the computing device to control a vertical axis turbine (VAT) comprising at least two turbine blades to enhance the performance of the VAT by:
integrating blade pitch control with the VAT, wherein blade pitch is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric),
wherein the blade pitch is continuously adjusted using actuators.
   In some embodiments, the second constant AoA is greater than the first constant AoA.

In a third aspect, a vertical axis turbine (VAT) is described comprising:
at least two turbine blades;
at least two actuators, wherein each turbine blade has a dedicated actuator and wherein a blade pitch of each blade is independently adjustable by the dedicated actuator;
a shaft, wherein the at least two turbine blades are arranged to rotate about the shaft;
a base or pedestal to support the shaft;
an anemometer; and
a computer program product communicatively connected to each actuator and the anemometer, wherein the computer program product comprises a computer readable storage medium having program instructions embodied therewith, the program instructions executable by a computing device to cause the computing device to control the VAT to enhance the performance of the VAT by:
integrating blade pitch control with the VAT, wherein blade pitch is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric),
   wherein the blade pitch of each blade is continuously adjusted using the actuators.
   In some embodiments, the second constant AoA is greater than the first constant AoA.

Advantageously, the system, method and computer program product described herein relates to a viable pitch turbine, i.e., the pitch angle of each turbine blade varies with its position (i.e., azimuthal angle as defined herein), which is an improvement over the prior art having fixed pitch turbines (e.g., G. Abdalrahman et al, 2017; L. Li et al., 2021).

### Computer Program Products

The present subject matter described herein may be a system, method and/or a computer program product. In some embodiments, the computer program product may include a computer readable storage medium (or media) having computer readable program instructions thereon for causing a processor to carry out aspects of the present subject matter.

In some embodiments, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

In some embodiments, the computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In some embodiments, the computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Example

### 1. Design of Blade Pitch Control Methods

### A. Fundamental VAT Physics

In this section, some of the fundamental flow physics related to VATs is briefly discussed. One of the most important physical parameters being used in VATs is the TSR λ, which is the ratio of the tangential velocity of the blades to the velocity of the freestream fluid [G. Abdalrahman et al, 2017]:

$$λ = \frac{ω R}{{U}_{∞}} , \qquad ( 1 )$$

where ω is the angular velocity of the turbine, R is the turbine radius, and U∞ is the freestream velocity. TSR, together with the turbine solidity and Reynolds number, is crucial to determine the performance of a VAT. The solidity σ is defined as σ=N_{B}C/D, where N_{B} is the number of blades, C is the chord length of the blade, and D is the turbine diameter. It describes the area that the blades occupy in reference to the frontal area of the turbine. For a VAT, the frontal area is calculated from D·H, where H is the height of the turbine rotor. As has been reported by Rezaeiha et al. [A. Rezaeiha et al., 2018], the optimal TSRs of VATs with a fixed installation angle to achieve the largest efficiency vary under different solidities. For the purposes of the present disclosure, the turbine solidity is fixed at the value of 0.429 (see below in Table 1) where the VAT can achieve the maximum energy harvesting efficiency (i.e., time-averaged power coefficient) at a TSR between 2.0 and 2.5 (i.e., a medium TSR). The Reynolds number can be defined globally based on the turbine diameter as Re_{g}=U_{∞}D/v, where v is the fluid kinematic viscosity, or be defined locally based on the airfoil chord length as Reₗ=ωRC/v. Note that Reₗ and Re_{g} are connected through the TSR λ, solidity σ, and blade number N_{B}. According to [K. Liu et al., 2021], the larger the Reynolds number is, the higher the energy harvesting efficiency of a VAT is.

TABLE 1
Basic turbine design parameters.

| Turbine attributes | Model |
|---|---|
| Blade airfoil | NACA0015 |
| Number of blades | 3 |
| Chord length | 0.2 m |
| Radius | 0.7 m |
| Height | 1.0 m |
| Solidity | 0.429 |

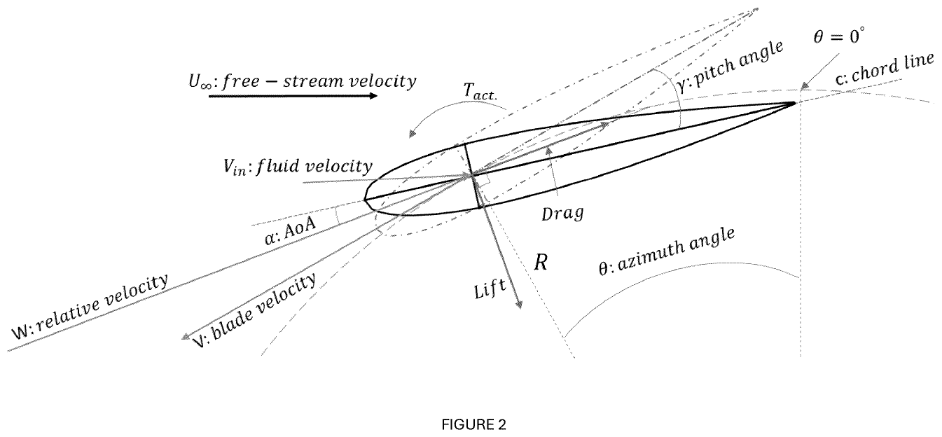

Another important physical parameter is the AoA, or α (see, FIG. 2), which is the angle between the relative velocity vector and the chord line of the airfoil. For blade pitch control, the physical pitch of a blade can be defined by the angle between the tangential velocity vector of the blade and the chord line of the blade, and is represented by γ. This is referred to as “pitch angle” in FIG. 2. Note that FIG. 2 is also used to reference the different geometric relationships that govern the VAT's kinematic behavior. Therein, θ is the azimuthal angle, the starting position (i.e., θ=0°) of which is defined in FIG. 1(a). The expression for AoA is given as follows: [M. Islam et al., 2008]

$$α = arctan [ \frac{sin θ}{( ω R / {U}_{∞} ) / ( {V}_{a} / {U}_{∞} ) + cos θ} ] - γ \qquad ( 2 )$$

Herein, Vₐ is the induced velocity, which is used to approximate the flow velocity near the turbine. Note that the induced velocity is an oversimplification of the flow velocity from the complex fluid dynamic phenomenon near rotating VAT blades, and for the control purpose, it can be assumed to be equivalent to the freestream velocity U_{∞}. When an aerodynamic or hydrodynamic model, instead of high-fidelity CFD, is used to evaluate the turbine performance, Vₐ cannot be simply approximated by U_{∞}. Additionally, note that the expression R_{ω}/U_{∞} is simply the TSR λ. As a result, Eq. (2), can be simplified into a more useful form in the present disclosure:

$$α = arctan [ \frac{sin θ}{λ + cos θ} ] - γ . \qquad ( 3 )$$

If the equation is rearranged where the desired AoA profile is specified, then the pitch angle that the controller uses to change the blade pitch can be solved for.
i. Energy Harvesting Efficiency Evaluation

The total power of a VAT can be calculated from [K. Liu et al., 2019; P. Lap-Arparat et al., 2019]:

$$P = T ω = ( {F}_{t} R + {T}_{res} ) ω , \qquad ( 4 )$$

where P is the total power, T is the signed magnitude of the total torque along the turbine axial direction with respect to the turbine shaft, Tᵣₑₛ is the signed magnitude of the total residual torque along the turbine axial direction when all loads are lumped to the installation point (e.g., aerodynamic center) of the blade, and Fₜ is the signed magnitude of the total tangential force acting on N_{B} blades. Note that Fₜ is determined by the aerodynamic lift and drag of the turbine blades, and Tᵣₑₛ equals to the signed aerodynamic moment acting on the installation point of the blade.

Since the turbine uses actuators to pitch the turbine blades, understanding how much energy it takes to run the actuators is an important factor to evaluate the net energy harvesting efficiency of the turbine. As described herein, the pivot point of the pitch motion coincides with the installation point of the blade, and light materials were used to manufacture the turbine blades. Therefore, if the moment of inertia of the blade is neglected, the torque exerted by the actuator with respect to the pitch pivot of the blade equals to the residual torque Tᵣₑₛ with respect to the same pivot point. This assumption has been widely used in the estimation of the propulsion efficiency and energy harvesting efficiency with oscillating foils [M. Yu et al., 2013; Q. Xiao et al., 2014]. As a result, the residual torque Tᵣₑₛ can be used to approximate the actuator torque which is used to estimate the energy consumption of actuators. A caveat is that when Tᵣₑₛ is negative, it indicates that the actuator would be generating power which is not a feasible way to generate power in reality; instead, the actuator needs to consume energy to resist such aerodynamic torques. Therefore, a conservative way to estimate the reacting torque of the actuator as T_{act}=|Tᵣₑₛ| is used. The resulting actuator torque can be used to calculate the power that the actuator consumed as

$${P}_{act} = {T}_{act} {ω}_{act} , \qquad ( 5 )$$

where ω_{act} is the angular velocity of the pitch motion of the turbine blade.

Finally, the energy harvesting efficiency of the turbine, i.e., the net (or effective) power coefficient C_{P}, can be calculated from

$${C}_{P} = \frac{P - {P}_{act}}{{P}_{fluid}} , \qquad ( 6 )$$

where P_{fluid}=0.5ρU³_{∞}A is the total power that can be extracted by the VAT from moving fluids. The reference area A is calculated as the multiplication of the turbine diameter D and turbine rotor height H. In 2D analysis, H can be assumed to be a unit value, e.g., 1 m herein. Another useful nondimensional parameter in turbine performance analysis is the torque coefficient C_{Ti} for each turbine blade defined by

$${C}_{{T}_{i}} = \frac{{T}_{i}}{0.5 {ρU}_{∞}^{2} AR} , i = 1 , ... , {N}_{B} , \qquad ( 7 )$$

where Tᵢ is the signed magnitude of the torque acting on the i^{th} blade along the turbine axial direction. For the purposes of this example, the phase-averaged torque coefficient C_{T} for one turbine blade was used to reveal flow physics associated with local turbine blades.

Three types of averaging procedures were used herein. Since the turbine torque and power histories show periodicity or quasi-periodicity (due to flow unsteadiness), “time-averaged” is intended herein to mean the data for the entire turbine was averaged in several (e.g., five in this example) successive cycles, and one scalar value is obtained from the averaging procedure. One example is the time-averaged net (or effective) power coefficient, which was used to measure the overall performance of the turbine. “Phase-dependent” is intended to mean the data for the entire turbine was categorized into the azimuth-angle-based phase space, and was then averaged in several successive cycles. One example is the phase-dependent net power coefficient curve, which was used to characterize the overall turbine performance at each azimuth angle. “Phase-averaged” is intended to mean the data for each turbine blade was categorized into the azimuth-angle-based phase space, and was then averaged in several successive cycles and over N_{B} blades. One example is the aforementioned phase-averaged torque coefficient, which was used to characterize the individual turbine blade performance at each azimuth angle.

### B. Control Method Development

Now that the physical attributes have been explained, the blade pitch controller itself can be explained. The constant AoA function appears to have the best performance potential. However, for completeness a sinusoidal AoA control was also designed for comparison purposes.

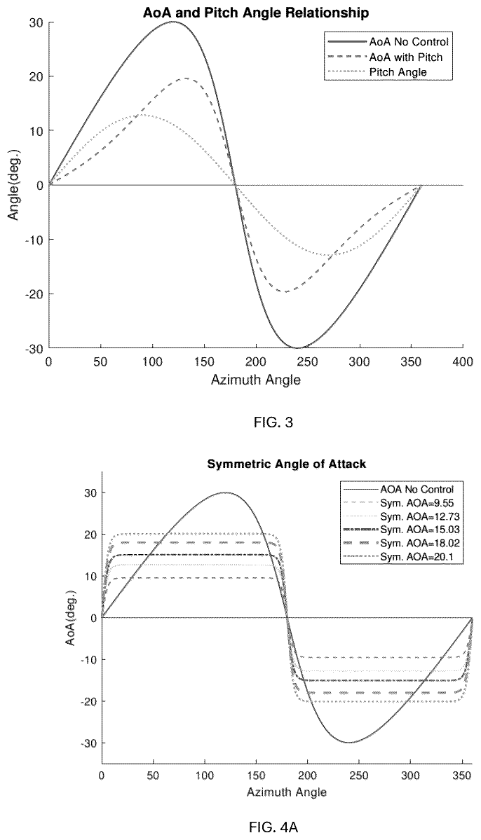

The sinusoidal AoA control function was arranged such that the function would reduce the AoA to prevent the blades from stalling at a high AoA. The relationship between the AoA without control and how the pitch angle modifies the AoA of the turbine blade are shown in FIG. 3. The performance of this approach will be discussed in Sect. 3 of this example.

The constant AoA function is significantly more complex than the basic sinusoidal AoA control. To add to the complexity, there are a plethora of different variables and forms of the AoA control function. For the purposes of the present disclosure, the two main forms will be referred to as symmetric AoA control and asymmetric AoA control.

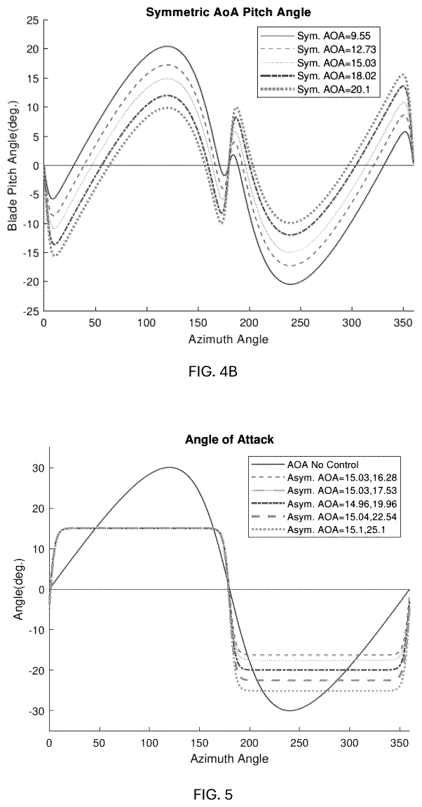

In the symmetric AoA control, the control function only has one AoA amplitude variable, and this variable is used to adjust the geometric AoA of the turbine blades. FIG. 4a shows the different primary symmetric AoAs that were used herein, and the corresponding pitch angles to achieve the desired AoAs are presented in FIG. 4b. Note that pitch angle functions were solved from Eq. (3).

The asymmetric AoA function has an even greater number of variables, e.g., different combinations of the upstream and downstream AoAs, to adjust compared to the symmetric AoA function. To reduce the computational cost, the upstream AoA was based on the best performing AoA from symmetric AoA simulations, and the downstream cycle was subsequently varied for these simulations. The different primary asymmetric AoAs used herein are presented in FIG. 5. Note that for the purposes of the simulation, the downstream AoA was larger than the upstream one. The reasoning behind this approach is to account for the unsteady behavior that the upstream cycle produces, which decreases the amount of energy that the downstream cycle can extract. This strategy is learned from the low TSR cases without control, in which the turbine blade can create a reasonably large positive torque to boost turbine performance during the blade downstream cycle. Flow physics will be explained in Sect. 3B and 3D.

### 2. Simulation Scope and Setup

The VAT used herein was designed such that the optimum TSR value was between 2.0 and 2.5. Since the freestream velocity that the turbine was subjected to cannot be controlled, it was essential that the turbine was able to achieve its maximum efficiency at a lower TSR [A. Rezaeiha et al., 2018]. This behavior would effectively allow a real turbine to spin slower, reducing the vibration frequencies as well as the wear cycles to increase the working life of the turbine. Although this approach increases the torque that the turbine generates, it was easier to design to accommodate larger loads than using an approach that requires axial balancing to reduce vibration. Moreover, lower TSRs usually indicate less noise emission and less harm to animals. These are desired features of VATs for real-world applications. The turbine parameters used in this example are summarized in Table 1.

A very large number of simulations were run for this example in order to obtain a good understanding of how the turbine's performance changes across different wind speeds and TSRs. Specifically, three different wind speeds were selected, namely, 3.5 m/s, 7 m/s and 14 m/s. These wind speeds were chosen because they encompass a large variety of wind conditions that the turbine is expected to be subjected to regularly. For each wind speed five different TSRs were simulated, including 1.5, 2, 2.25, 2.5, and 3. The large range of TSRs used was to find the best performance of the turbine as well as gaining a better understanding of how the turbine may perform under real-world conditions. For each of the different permutations, a regiment of different control scopes (i.e., different AoA designs) were simulated, as described in Sect. 1B of this example.

With all of the different permutations, a total of about 130 different cases were simulated in this study. Results were used to explain relevant flow physics in Sect. 3 of this example.

### A. Simulation Setup

For this example, ANSYS FLUENT® was used to carry out numerical simulations. The working fluid was selected as air (i.e., the VAT is used to collect wind energy) in this example, and the global Reynolds number defined as Re_{g}=U_{∞}D/v ranged from 3.3×10⁵, corresponding to 3.5 m/s wind, to 13.3×10⁵, corresponding to 14 m/s wind. The unsteady Reynolds-averaged Navier-Stokes (URANS) equations with the Spalart-Allmaras (S-A) turbulence model was used to conduct simulations. As demonstrated in Liu et al. [K. Liu et al., 2021], simulation results with the S-A turbulence model and those with the k−ω turbulence model recommended in Rezaeiha et al. [A. Rezaeiha et al., 2019] have marginal differences. The Semi-Implicit Method for Pressure-Linked Equations (SIMPLE) algorithm with a second-order upwind spatial discretization scheme was used to discretize the URANS equations in space, and a second-order implicit transient formulation with a time step of 0.001 s was used for time marching. The residual convergence criterion for inner iterations in the implicit time method was fixed at 10⁻⁵. Similar to Liu et al. [K. Liu et al., 2019], the inlet turbulence viscosity ratio was set to 10 to give a reasonable estimation of the freestream turbulence. The simulation models and parameters are summarized in Table 2.

TABLE 2
Numerical simulation setup in ANSYS-Fluent.

| Input variable | Setting/value |
|---|---|
| Turbulence model | S-A |
| Pressure velocity coupling | SIMPLE |
| Spatial discretization scheme | Second-order upwind |
| Time integration | Second-order implicit |
| Inlet turbulence viscosity ratio | 10 |
| Convergence criterion for residuals | 10⁻⁵ |
| Global Reynolds number Re_{g} | 3.3-13.3 × 10⁵ |
| Time step | 0.001 s |

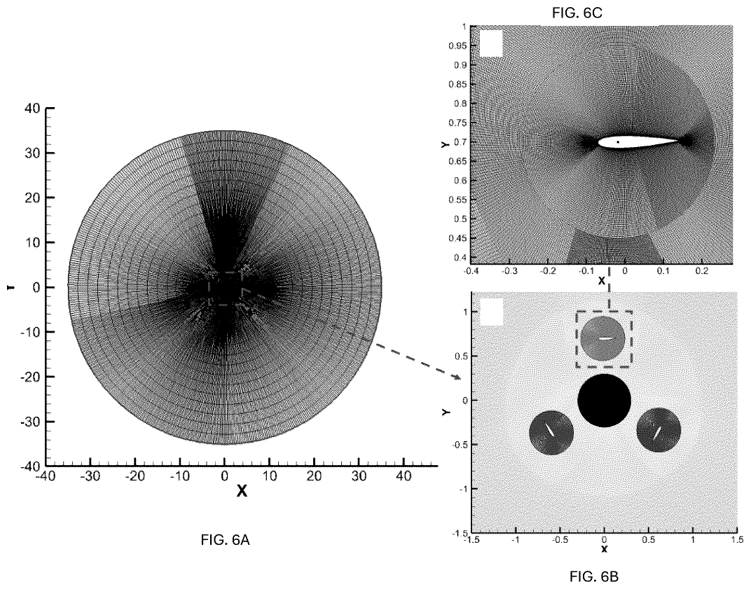

The meshes used in all simulations were based on those used in previous works conducted in a similar research context for the vertical-axis wind turbine operating at 10 m/s wind [K. Liu et al., 2019] and for the vertical-axis hydro-kinetic turbine operating at up to 3 m/s water current (equivalent to about 30 m/s wind) [K. Liu et al., 2021]. Therein, extensive mesh convergence studies have been carried out to control the numerical uncertainty to minimum. Specifically, three sets of meshes consisting of 60,579 (coarse), 209,324 (medium), and 550,484 (fine) elements were used in Liu et al. [K. Liu et al., 2019] to carry out grid refinement studies of a Darrieus-type vertical-axis wind turbine with TSR varying between one and two at a global Reynolds number of 4.9×10⁵. Simulation results from the medium and fine meshes agreed well with each other, and with reference data from other numerical simulations [C. Li et al., 2013] and experiments [K. W. McLaren, 2011] as well. Therein, the averaged y⁺ of the first layer of the medium mesh was about 0.25. In another work [K. Liu et al., 2021], three sets of meshes with 71,940 (coarse), 221,840 (medium), and 715, 680 (fine) elements were tested for a Darrieus-type vertical-axis water turbine with TSR=2.5 at a global Reynolds number of 34.8×10⁵. Similarly, simulation results from the medium and fine meshes agreed well with each other, and the averaged y⁺ for the first layer of the medium mesh was about 0.4. In this example, a mesh consisting of 349,200 elements with the averaged y⁺≈0.4 at Re_{g}=13.3×10⁵ was adopted to conduct numerical simulations. An overview of the mesh and details around turbine blades are presented in FIG. 6. As seen in FIG. 6A, the mesh was constructed to be 70 m in diameter to account for open-air conditions. FIG. 6B shows the different regions that make up the mesh. The green, red, and blue circles are the sliding meshes that surround each blade, their center point is aligned with the aerodynamic center for the blades or C/4 from the leading edge. The meshes near each turbine blade are shown in FIG. 6C. To account for the global rotational motion of the turbine, the entire mesh rotated at a constant angular velocity, determined from TSR and the freestream velocity, about the central axis of the turbine.

In this example, the motion of the sliding mesh associated with a specific turbine blade was determined by the controller input for the blade. The User Defined Functions (UDFs) were used to create specific blade pitch motions around the pivot point, i.e., the aerodynamic center of the blade. Since fluid dynamics simulations utilized discrete time steps, the pitch control was updated every time step to approximate a continuous function while balancing computational cost. For every simulation, to keep results consistent, 25 rotation cycles of the turbine were simulated. The data processing was conducted with data from the last five cycles.

### 3. Results and Discussion

### A. Summary of VAT Performance

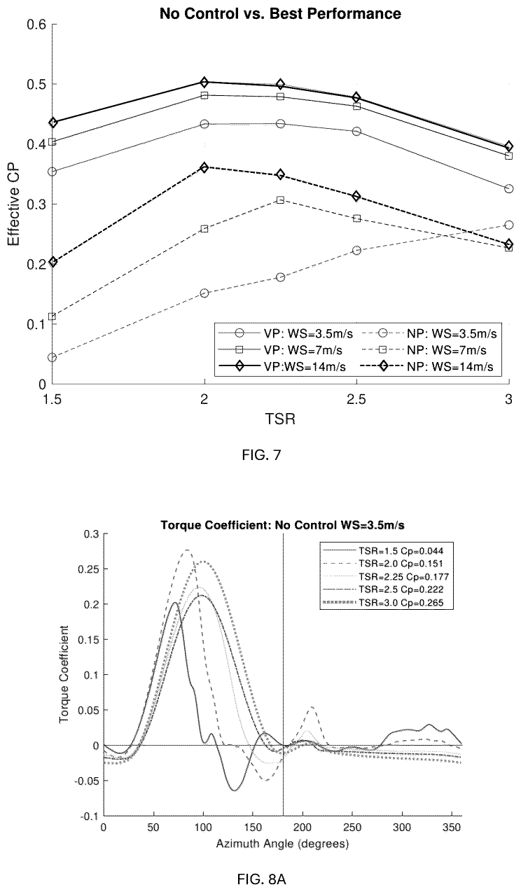

The maximum time-averaged net power coefficients C_{P} that the turbine achieved with respect to the TSR at different wind speeds were summarized to get an understanding of the turbine's overall performance with constant AoA (either with symmetric AoAs or with asymmetric ones) pitch control. As seen in FIG. 7, the constant AoA control approach can significantly improve the turbine energy harvesting efficiencies, especially at low wind speeds and low TSRs. For example, as presented in Table 3, when the wind speed is at 3.5 m/s and the TSR is 1.5, the largest C_{P}=0.353 is achieved through the asymmetric AoA control with a constant AoA of 15.03° through the upstream cycle of the turbine and 16.28° downstream. Compared to the baseline case without control (C_{P}=0.044), the power coefficient was increased by about seven times. By further analyzing the data presented in FIG. 7 and Table 3, the following were observed:
Observation 1. No matter for the baseline cases without control or for the cases with blade pitch control, the higher the wind speed (i.e., Reynolds number) is, the larger the power coefficient is in general. This agrees with the observations from previous studies on vertical-axis hydrokinetic turbines [K. Liu et al., 2021].
Observation 2. The optimal TSR for the VAT without control varies with wind speeds. However, when blade pitch control is adopted, the optimal TSR is stabilized around two, which is also about the theoretical optimal TSR when the solidity of the VAT is 0.429 at high Reynolds numbers, no matter in wind or water [A. Rezaeiha et al., 2018; K. Liu et al., 2019; K. Liu et al., 2021].
Observation 3. Based on previous two-way fluid-structure interaction studies [Y. Bazilevs et al., 2014; K. Liu et al., 2019], a VAT is hard to accelerate to high TSRs, e.g., TSR=3, depending on its structure and mass distribution. Since power coefficients of the controlled VATs peak around TSR=2, the blade pitch control can be effective in practical applications.
Observation 4. Although not presented in Table 3 (see the full data sets in [K. S. Wisner, 2023]), the blade pitch control can enhance the VAT performance in a large parameter space. Take the case with wind speed (WS) of 14 m/s and TSR=1.5 as an example. The energy harvesting efficiency of the baseline case without control is 0.202, and the blade pitch control with constant AoAs can improve the efficiency to 0.414 when the symmetric AoA of 15.03° is used, to 0.435 (symmetric AoA of 18.02°), to 0.420 (asymmetric AoAs of 15.03° in the upstream cycle and 16.28° downstream), to 0.425 (asymmetric AoAs of 15.03° upstream and 17.53° downstream), and to 0.426 (asymmetric AoAs of 14.96° upstream and 19.96° downstream). This indicates that robust blade pitch control can be designed to improve the VAT performance.

TABLE 3
Turbine overall performance (time-averaged effective C_{P}) improvement summary.

| TSR | WS (m/s) | Baseline | Best perf. | Control AoAs (°) | Improvement (%) |
|---|---|---|---|---|---|
| 1.5 | 3.5 | 0.044 | 0.353 | 15.03 (u), 16.28 (d)* | 704 |
| 1.5 | 7 | 0.113 | 0.403 | 15.03 (u), 17.53 (d) | 285 |
| 1.5 | 14 | 0.202 | 0.435 | 18.02^{†} | 115 |
| 2 | 3.5 | 0.151 | 0.433 | 15.03 (u), 17.53 (d) | 187 |
| 2 | 7 | 0.259 | 0.481 | 15.03 (u), 17.53 (d) | 86.0 |
| 2 | 14 | 0.360 | 0.503 | 15.03 (u), 17.53 (d) | 39.6 |
| 2.25 | 3.5 | 0.177 | 0.433 | 15.03 (u), 17.53 (d) | 144 |
| 2.25 | 7 | 0.307 | 0.478 | 15.03 (u), 17.53 (d) | 56.1 |
| 2.25 | 14 | 0.349 | 0.499 | 15.03 (u), 16.28 (d) | 43.2 |
| 2.5 | 3.5 | 0.222 | 0.421 | 12.73 | 89.3 |
| 2.5 | 7 | 0.275 | 0.463 | 12.73 | 68.1 |
| 2.5 | 14 | 0.312 | 0.478 | 12.73 | 52.9 |
| 3 | 3.5 | 0.265 | 0.337 | 12.06 | 27.4 |
| 3 | 7 | 0.226 | 0.388 | 12.06 | 71.2 |
| 3 | 14 | 0.219 | 0.403 | 12.06 | 83.7 |

*“u” stands for the upstream cycle, and “d” stands for the downstream cycle.
†C_{P} for the case with 15.03 (u), 17.53 (d) is 0.425, and the improvement is 110%.

It is noted that the VATs with blade pitch control studied in this example outperform most contemporary VATs of similar initial setups but with various control strategies. As summarized by Zhao et al. [Z. Zhao et al., 2022], several VATs have a maximum C_{P} value of about 0.4, and many others have power efficiencies below 0.35.

### B. No Control Baseline

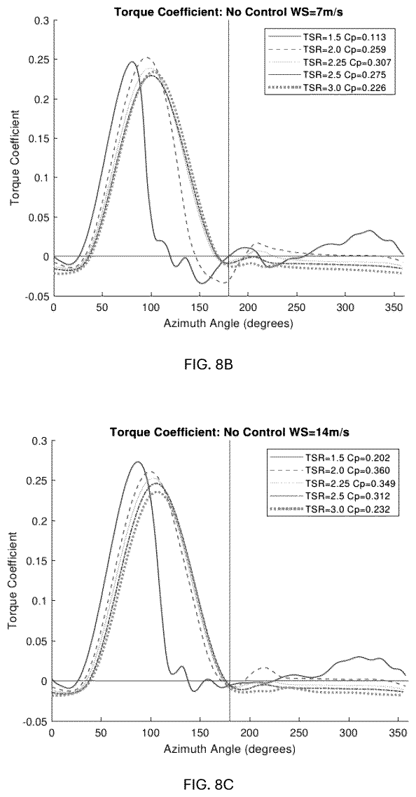

To understand how pitch control affects the performance of the turbine, the baseline performance without control was first analyzed. To facilitate physics analysis, the phase-averaged torque coefficient for one turbine blade was presented as a function of the azimuth angle. FIGS. 8A, 8B, and 8C present the phase-averaged torque coefficients at different wind speeds and TSRs. The corresponding effective power coefficients of the turbine are also listed. The vertical line in the middle of the graphs indicates the separation of the upstream cycle from the downstream cycle. In general, the upstream cycle is primarily responsible for the torque production. An interesting observation from FIGS. 8A-8C is that although the effective power coefficient of the turbine is small at low TSRs, such as 1.5, the individual turbine blade can create positive torque during the downstream cycle. Without being bound by theory, it is believed that when the TSR decreases, the blade velocity decreases relative to the incoming fluid velocity. As illustrated in FIG. 2, when the fluid velocity Vᵢₙ remains constant, a decrease of the blade velocity creates a large AoA (see FIG. 1B). This large AoA causes blade stall during the blade upstream cycle (see, for example, the cases with TSR=1.5 in FIGS. 8A and 8B). However, due to that the spatially averaged flow velocity experienced by the blades operating during their downstream cycle is smaller than the freestream velocity, the AoA experienced by the downstream blade is actually smaller than the nominal values presented in FIG. 1B. Although its exact value is hard, if not impossible, to determine from the highly unsteady flow field, its effect is to increase the effective TSR, thus boosting lift as well as positive torque production during the blade downstream cycle. This indicates that with appropriate blade pitch control, there is a chance to maintain high energy harvesting efficiency during the upstream cycle while boosting energy extraction during the downstream cycle. The asymmetric AoA control was inspired by this observation.

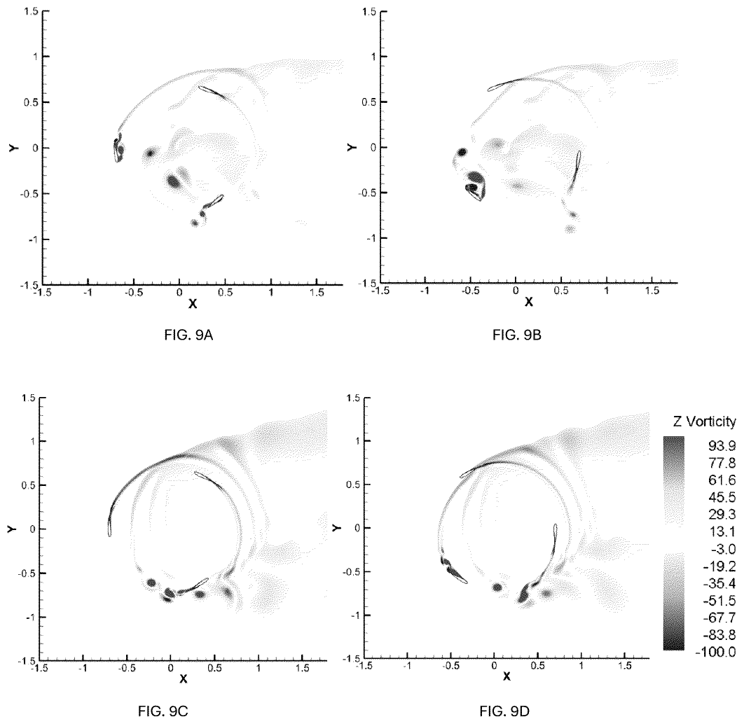

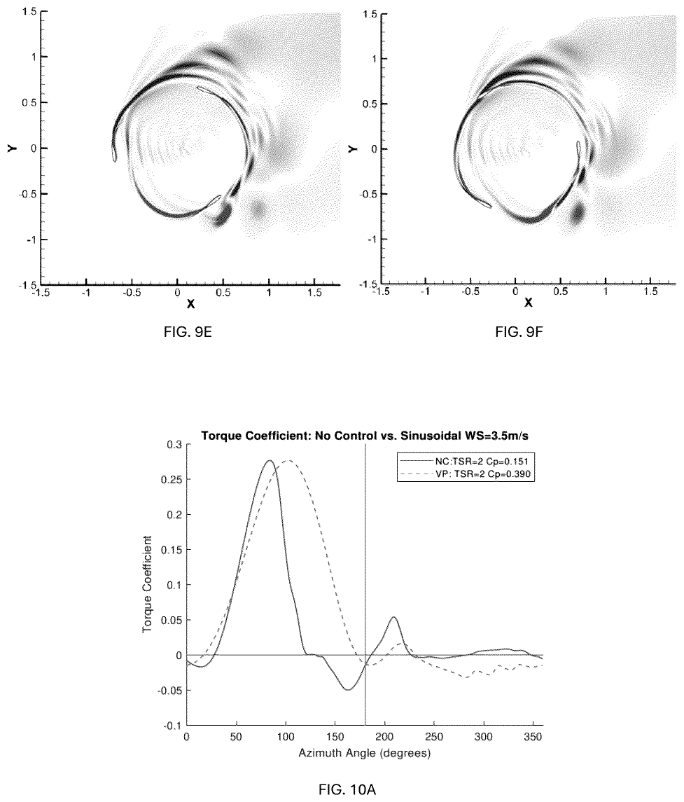

Next flow fields were used, together with the phase-averaged torque coefficients, to explain flow physics behind different turbine performance. The discussions are divided into two parts, focusing on the upstream and downstream cycles separately. The flow physics from the upstream cycle has been studied by many researchers [K. W. McLaren, 2011; S. H. Hezaveh et al., 2017; C. Li et al., 2013; K. Liu et al., 2019; A.-J. Buchner et al., 2015]. The poor performance during the upstream cycle is closely related to the blade stall phenomenon. Take the case with TSR=1.5 at the wind speed of 3.5 m/s as an example. As shown in FIG. 9A, the leading blade around an azimuth angle of 90° is beginning to stall, and in FIG. 9B, the blade is fully stalled due to the large AoA experienced by the blade, as explained in FIG. 1B. The stall is depicted by the formation of a vortex pocket that is separating from the surface of the blade. As a result, the airfoil is unable to effectively accelerate the flow over the low-pressure side of the airfoil, thus, causing a dramatic decrease in the lift being produced. This induces small positive and even large negative torques (see FIG. 8A), depending on the stall severeness. However, fully suppressing flow separation during the upstream cycle is also not ideal for turbine performance enhancement. As shown in FIGS. 9E and 9F with TSR=3 and wind speed of 14 m/s, no flow separation is observed over the blade during the upstream cycle, creating the smallest peak positive torque due to the limited amount of lift created at small AoAs (see FIG. 8C). When the blade AoA is pushed to its dynamic stall boundary, e.g., TSR=2.25 and wind speed of 7 m/s, moderate flow separation dominates over the suction surface of the blade, and consistently bolsters lift generation during the upstream cycle of the blade until the blade moves into its downstream cycle where the suction and pressure surfaces of the blade switch with each other. This blade-vortex interaction process is shown in FIGS. 9C and 9D for the case with TSR=2.25 and wind speed of 7 m/s, and the corresponding phase-averaged torque coefficient is presented in FIG. 8B.

The flow physics from the downstream cycle is more complicated than that from the upstream cycle as the blades start interacting with unsteady wakes. Meanwhile, the averaged velocity encountered by turbine blades is smaller compared to that during the upstream cycle. It was observed that as long as the turbine blade encounters strong wakes, its aerodynamic performance can hardly be guaranteed; see the flow fields and the corresponding phase-averaged torque coefficients during the downstream cycle of the turbine in FIGS. 9C-9F and FIG. 8. This characteristic is one of the reasons why turbines with larger solidities typically decrease in efficiency as the TSR increases [A. Rezaeiha et al., 2018]. The larger the solidity, the comparatively larger the blades are, meaning the wake that they generate is stronger at larger TSRs. This results in the negative wake interaction occurring at larger TSRs compared to turbines with smaller solidities. At low TSRs, especially when the azimuth angle exceeds 270°, as shown in FIGS. 9A-9B, the wake strength is low and the interaction between the turbine blade and wake is also mild. As a result, the blade's aerodynamic performance can be boosted as observed from FIG. 8A. This indicates that to improve the turbine energy harvesting performance during its downstream cycle, one effective way is to reduce the blade-wake interaction, and if the interaction is unavoidable, short-term dynamic stall, from which the turbine blade can momentarily generate a large amount of unsteady lift even if the AoA is above its stall AoA, can be utilized to temporarily boost the turbine performance; see Sect. 3D of this example.

### C. Sinusoidal AoA Control

The most straightforward blade pitch control mechanism is arguably the sinusoidal AoA control. Based on previous tests [K. S. Wisner, 2023], the sinusoidal AoA control that had the best performance relative to the baseline was for a wind speed of 3.5 m/s and a TSR of 2 with an sinusoidal amplitude of π/14 or approximately 12.86°. This coupled with the relatively low Reynolds number effect allows the sinusoidal AoA control to have a dramatic impact on the performance of the turbine increasing the effective C_{P} from 0.151 to 0.390. According to FIG. 10A, the control can significantly improve the blade performance in the upstream cycle by suppressing stall via reducing the AoA (see FIG. 3). However, the control was counterproductive during the downstream cycle.

FIG. 10B shows the performance degradation that the sinusoidal AoA control caused for the wind speed of 7 m/s and the TSR of 2. The sinusoidal amplitude is π/9 or 20°, causing the peak effective AoA experienced by the turbine blade around 10°. The performance degradation is attributed to the poor blade performance during the downstream cycle, where not enough lift was created to drive the motion of the blade due to the small effective AoA.

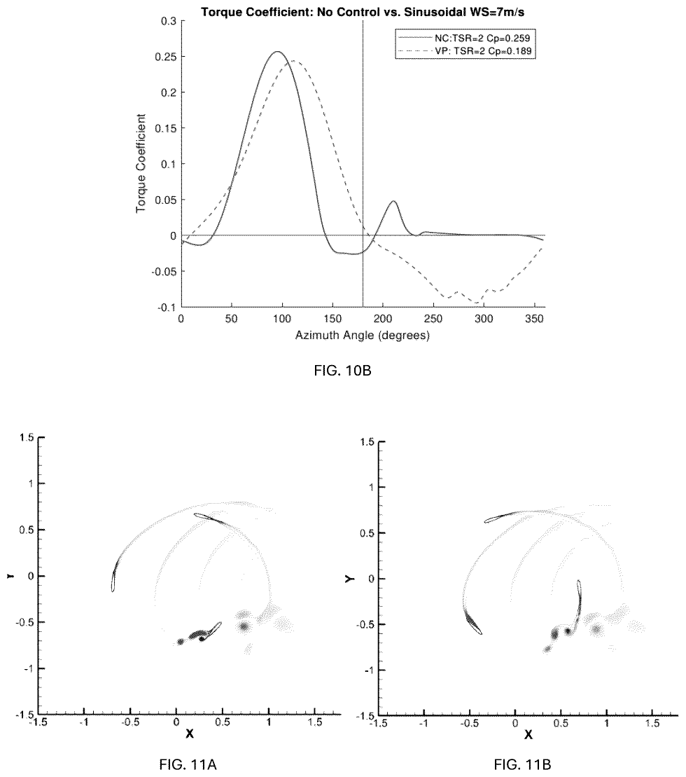

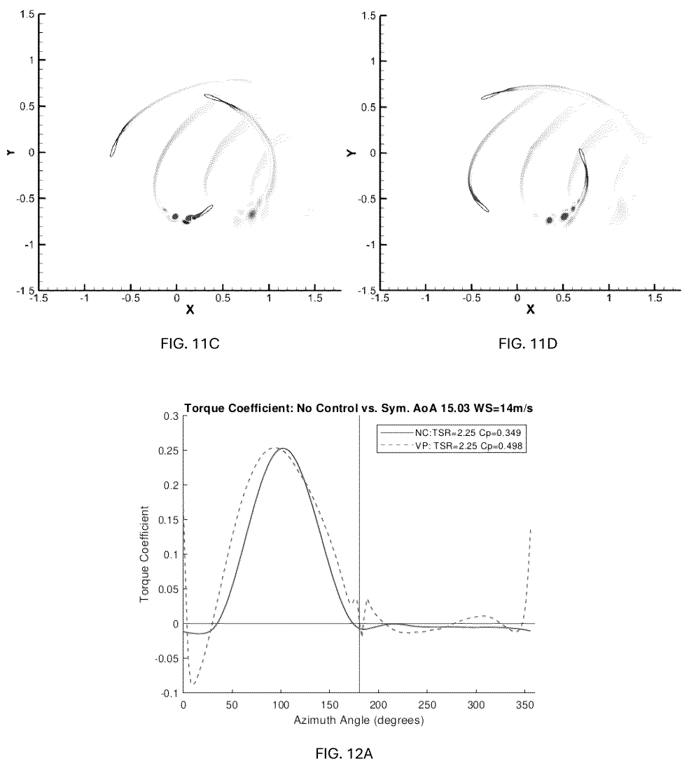

The flow fields associated with the two cases are depicted in FIGS. 11A-11D, where the best performing case is presented in FIGS. 11A and 11B while the worst case in FIGS. 11C and 11D. The vorticity fields seem similar although there exist certain differences. For the more efficient turbine in FIG. 11B, the blade that is at approximately at the 150° position generates a larger counter-clockwise vortex region when compared to the blade in the same position in FIG. 11D. This is believed to be due to the larger effective AoA experienced by the turbine blade of the more efficient turbine, and explains why the peak torque coefficient during the upstream cycle in FIG. 10A is larger than that in FIG. 10B. It is hard to correlate the poor downstream performance of the turbine directly with flow fields. However, it is evident that the sinusoidal AoA control cannot reduce the blade-wake interaction. As mentioned in Section 3B, this is in general not favorable for turbine performance enhancement.

### D. Constant AoA Control

As shown in FIGS. 4A-4B, the turbine blade needs to constantly pitch to maintain a constant effective AoA experienced by itself, and at the azimuth angles 0° and 180°, the blade has a high pitch rate to switch from the downstream AoA to the upstream one, or vice versa.

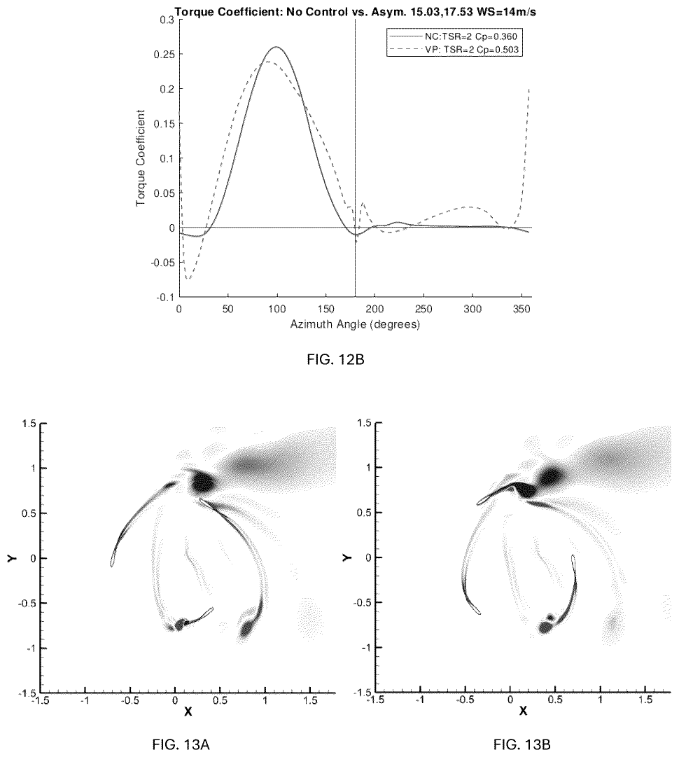

FIG. 12 shows two typical phase-averaged torque coefficient for one turbine blade from symmetric AoA control with AoA=15.03° at the TSR of 2.25 and wind speed of 14 m/s (FIG. 12A) and asymmetric AoA control with an upstream AoA of 15.03° and a downstream AoA of 17.53° at the TSR of 2 and wind speed of 14 m/s (FIG. 12B). Both cases have high power coefficients of around 0.5. A common and interesting feature from the two cases is the sudden positive torque boost at the transition location from the blade downstream cycle to the upstream one (i.e., the azimuth angle 360° or 0°). It is believed that this phenomenon is due to the unsteady lift enhancement from the dynamic stall of the turbine blade. As shown in FIG. 13 for the asymmetric AoA control case, when the turbine blade approaches the azimuth angle 360° or 0°, it encounters a large vortex shed by the previous blade, and captures the vortex (as seen in FIG. 13A) to create high unsteady lift (i.e., the mechanism of dynamic stall), bolstering positive torque production; when the blade passes the azimuth angle 0°, as shown in FIG. 4, it quickly pitches to switch to the desired upstream AoA, and sheds the vortex into the wake (as seen in FIG. 13B) to be utilized by the successive turbine blade.

Another common feature of the two cases is that a similar, but mild, unsteady lift enhancement through dynamic stall also occurs at the azimuth angle 180°, where the transition from the blade upstream cycle to the downstream one occurs. However, because the vortex shed by the previous turbine blade moves in the same direction as that of the successive blade, the successive blade cannot capture the wake vortex to significantly boost lift generation, as is done near the azimuth angle 360° or 0°. As a result, the unsteady lift enhancement is mild, but is still considerable compared to the cases without control (see FIG. 8) and those with the sinusoidal AoA control (see FIG. 10).
Comment 1. Flow fields from all constant AoA control cases with high power coefficients share a similar feature, which is short-term unsteady lift boost from dynamic stall at the two transition locations of the blade upstream and downstream cycles. Similar to Observation 4, this indicates that the constant AoA control strategy can be robust across a reasonably large control parameter space no matter with symmetric or asymmetric AoAs as similar flow physics shows up in this parameter space.

An apparent difference in phase-averaged torque coefficients between the symmetric and asymmetric AoA control shown in FIG. 12 is that the positive torque created during the blade downstream cycle by the asymmetric AoA control is larger than that by the symmetric AoA control, although the torques show similar patterns. Note that the asymmetric AoA control has an approximately 2.75° larger downstream cycle AoA compared to the symmetric one. The reason why a larger downstream AoA can bolster positive torque production is analogous to that explained for downstream positive torque production of the cases at low TSRs without control in Sect. 3B. Specifically, due to the decreased incoming fluid velocity experienced by the downstream turbine blade, the local AoA of the blade is smaller than the nominal value. Therefore, the nominal downstream AoA should be increased to boost turbine performance if the upstream AoA is close to its optimal value.
Comment 2. It is hard, if not impossible, to determine the optimal AoA that can take full advantage of dynamic stall to bolster blade lift production during the entire rotation cycle. For the cases at low TSRs without control as presented in Sect. 3B, the actual AoA experienced by the blade during its downstream cycle is smaller than the nominal large ones. Thus the performance of the blade during the downstream cycle is enhanced. In this section, the nominal downstream AoA was increased to enhance the control performance as it was expected that the smaller actual downstream AoA is close to its optimal value.

### E. Other Interesting Cases

This section explores what happens at the extremes when the constant AoA control was used. The turbines are selected to show interesting behaviors that exaggerate some of the characteristics previously discussed. All of the turbines in this section have an incoming wind speed of 7 m/s and a TSR of 2 to help draw more direct comparisons.

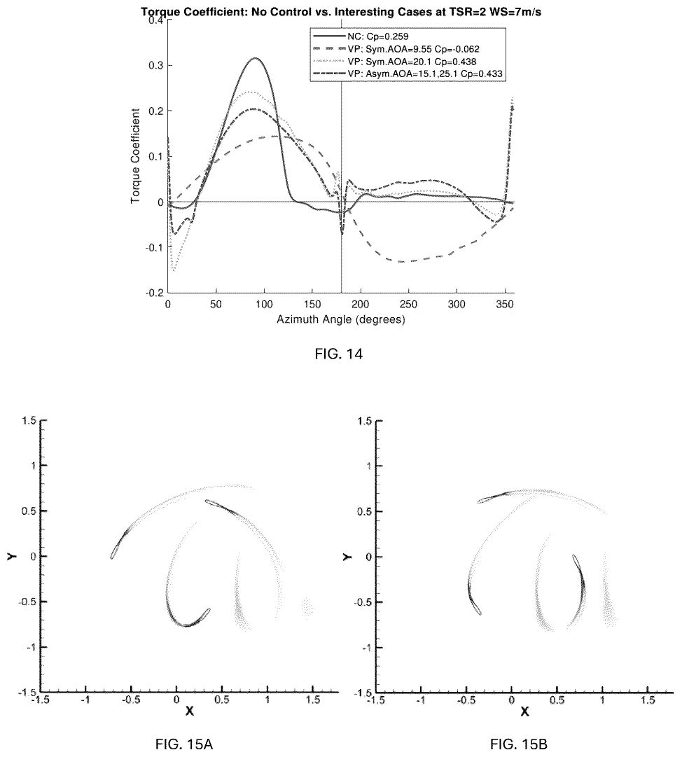

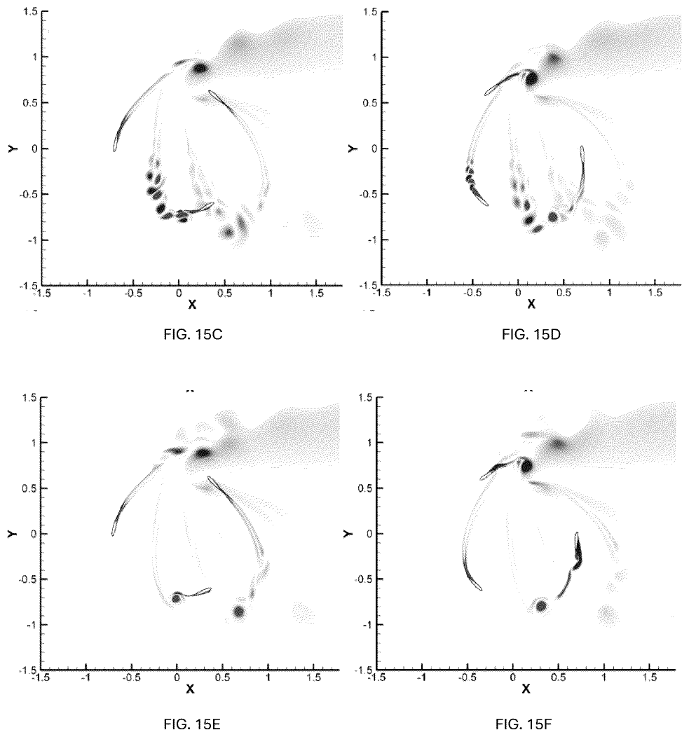

Three cases with constant AoA control were selected as follows. The first case has the symmetric AoA of 9.55°, at which no blade flow separation occurs. The second case has the symmetric AoA of 20.1°, at which moderate flow separation occurs on the blade. The third case uses the asymmetric AoA control with a constant AoA at 15.1° through the upstream cycle of the turbine and 25.1° downstream. The torque that the turbines generated are presented in FIG. 14. It was observed that the symmetric AoA control with an angle of 9.55° is similar to the sinusoidal AoA control with a large pitch amplitude (see FIG. 10B). The flow fields of the symmetric AoA case, as presented in FIGS. 15A-15B, also show similarity to those in FIGS. 1C-1D. This is not a surprise as the effective AoA experienced by the turbine blade during the downstream cycle is too small to create sufficient lift to sustain the blade motion. This again confirms the importance of a relatively large effective AoA on the blade performance during the downstream cycle. When the effective AoA is increased to 20.1°, dynamic stall shows up when the turbine blade passes the azimuth angle at 90° (see FIGS. 15C-15D), and the turbine blade interacts with complex wake structures shed from the previous blade at the azimuth angle about 180°. Since the blade at this position does not significantly contribute to lift (thus positive torque) generation, the power coefficient of the turbine can reach 0.438 (note that the best C_{P} under the same flow conditions is 0.481).

The last case that will be discussed is the asymmetric AoA control with AoAs of 15.1° upstream and 25.1° downstream. This case was interesting because the downstream cycle generates more torque than any other case. This fact is supported by the vorticity plots in FIG. 15F, where the blade that is approximately at the azimuth position of 270° does show evidence of moderate flow separation. This indicates that the blade is successfully producing beneficial lift. However, as shown in FIG. 14, although the downstream cycle generates a noticeable amount of positive torque, the torque dramatically decreases before spiking when the turbine approaches the upstream cycle, causing performance loss.

While the cases discussed in this section did not result in the best performance, they still offer important observations that can help researchers better understand how the turbines' performance develops as blade pitch control variables are manipulated.

### F. Overall Performance Discussion

In this section, the overall turbines performance with the turbine's phase-dependent power coefficient C_{P} is discussed. Different from the phase-averaged torque coefficient C_{T} which is based on one turbine blade, the phase-dependent power coefficient C_{P} is based on all three blades of the turbine.

The best performance that was achieved for each individual wind speed simulated was focused on (see Table 3 for reference). Specifically, when the wind speed is 3.5 m/s, the turbine achieves its best performance (i.e., time-averaged total C_{P} of 0.446 with an effective C_{P} of 0.433) with the asymmetric AoA control (15.03° upstream and 17.53° downstream) at TSR=2.25; when the wind speed is 7 m/s, the best time-averaged total C_{P} is 0.492 with an effective C_{P} of 0.481, achieved with the asymmetric AoA control (15.03° upstream and 17.53° downstream) at TSR=2; and when the wind speed is 14 m/s, the best time-averaged C_{P} is 0.514 with an effective C_{P} of 0.503, achieved with the asymmetric AoA control (15.03° upstream and 17.53° downstream) at TSR=2. Recall the definition of the net power coefficient in Eq. (6). Note that at the wind speed of 3.5 m/s and TSR of 2, the effective C_{P} is also 0.433, and the total C_{P} is 0.443. The flow physics is very similar to that of the case with the wind speed of 3.5 m/s and TSR of 2.25. Therefore, only the former case is discussed in this section. It was found that the power consumed by actuators to drive the blade pitch for all these cases is less than 3% of the effective power extracted by the turbine. This agrees with the observations in the studies of the propulsion efficiency and energy harvesting efficiency with oscillating foils [M. Yu et al., 2013; Q. Xiao et al., 2014].

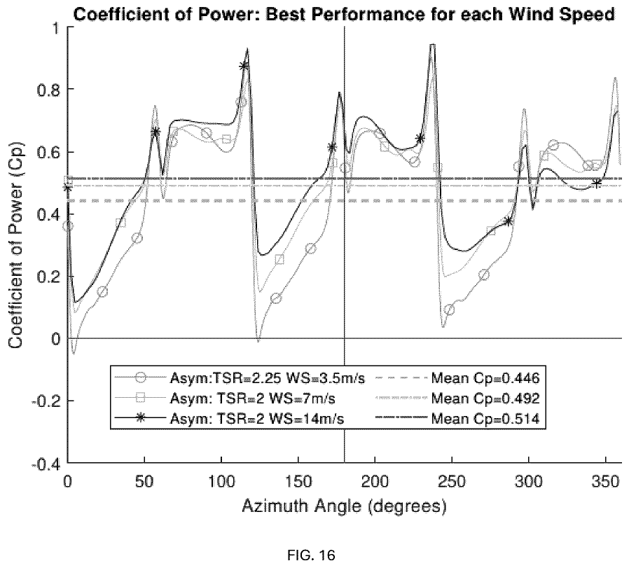

The phase-dependent total C_{P} of the aforementioned three cases are presented in FIG. 16. It was observed that each of these C_{P} plots follows a similar behavior indicating that the flow physics are similar, supporting previous observations in Sect. 3D of this example. There are three peak performance regions, i.e., [50°, 120°], [170°, 240°], and [290°, 360°], corresponding to where three blades have their best performance. However, the best performance is not uniform in these three regions due to the highly nonlinear unsteady blade-vortex interaction.

### 4. Conclusions

This example evidences the enhancement of VAT performance with physics-informed blade pitch control, showing the performance boost that can be achieved through the integration of blade pitch control with vertical-axis wind turbines. Through the procedural adjustment of different variables based on fundamental VAT physics, the turbine's overall time-averaged net power coefficients were observed to increase between 27.4% and 704.0% compared to that of the corresponding baselines without control.

The blade pitch control was based on constant AoA functions, which facilitate control mechanism implementation into real-world turbines. Both symmetric and asymmetric AoA control were designed and numerically tested with the aim of bolstering lift production over turbine blades through upstream and downstream cycles of the VAT. Key flow physics discovered from the phase-average torque coefficients of one turbine blade and the corresponding vorticity fields include:
(Upstream Cycle Lift Enhancement) To boost lift production over the turbine blade during its upstream cycle, the effective AoA needs to be pushed toward the limit where dynamic stall occurs over the blade. Although dynamic stall can temporarily enhance unsteady lift production, the resulting large vortex shedding can cause lift loss and affect downstream energy extraction. Thus, vortex shedding from the blade should be avoided during its upstream cycle.
(Downstream Cycle Lift Enhancement) Due to complex blade-wake interaction, the energy extraction performance of a turbine blade during its downstream cycle is inferior compared to that during its upstream cycle. However, considering that the averaged flow velocity experienced by downstream blades is smaller than the incoming flow velocity experienced by upstream blades, a slightly higher nominal AoA, as used in the asymmetric AoA control approach, can in general boost lift production during the blade downstream cycle.
(Unsteady Lift Enhancement with Dynamic Stall) Since vortex shedding from turbine blades is unavoidable in any VAT, short-term dynamic stall can be triggered at the transition locations of the upstream and downstream cycles to temporarily boost unsteady lift production, thus bolstering the overall turbine energy harvesting efficiency.

It was also discovered that the constant AoA control can enhance the VAT performance in a large parameter space. Fundamentally, designing a control function, such as the constant AoA function tested in this example, that has the capabilities to be modified or self-modified, would allow a controller to optimize its performance in real time. The actuator-based blade pitch control system gives the VAT discussed herein an advantage to boost its self-starting capability as the VAT with blade pitch control is capable of switching between the drag-dominated (e.g., adjusting the AoA of one upstream blade around 90° to make it function like a Savonius VAT blade, and simultaneously reducing the AoAs of the other two blades to suppress dynamic stall at low TSRs) and lift-dominated modes by changing the pitch angles of its blades. To assist self-starting, the drag-dominated mode can be used to accelerate the turbine rotor at the starting stage.

### REFERENCES

G. Abdalrahman, W. Melek, and F.-S. Lien, “Pitch angle control for a small-scale Darrieus vertical axis wind turbine with straight blades (H-type VAWT),” Renewable Energy, vol. 114, pp. 1353-1362, 2017.
Y. Bazilevs, A. Korobenko, X. Deng, J. Yan, M. Kinzel, and J. O. Dabiri, “Fluid-Structure Interaction Modeling of Vertical-Axis Wind Turbines,” Journal of Applied Mechanics, vol. 81, p. 081006, 05 2014.
A.-J. Buchner, M. Lohry, L. Martinelli, J. Soria, and A. Smits, “Dynamic stall in vertical axis wind turbines: Comparing experiments and computations,” Journal of Wind Engineering and Industrial Aerodynamics, vol. 146, pp. 163-171, 2015.
D. De Tavernier, C. Ferreira, and G. van Bussel, “Airfoil optimisation for vertical-axis wind turbines with variable pitch,” Wind Energy, vol. 22, no. 4, pp. 547-562, 2019.
S. H. Hezaveh, E. Bou-Zeid, M. W. Lohry, and L. Martinelli, “Simulation and wake analysis of a single vertical axis wind turbine,” Wind Energy, vol. 20, no. 4, pp. 713-730, 2017.
M. Islam, D. S.-K. Ting, and A. Fartaj, “Aerodynamic models for Darrieus-type straight-bladed vertical axis wind turbines,” Renewable and Sustainable Energy Reviews, vol. 12, no. 4, pp. 1087-1109, 2008.
B. Kirke and L. Lazauskas, “Limitations of fixed pitch Darrieus hydrokinetic turbines and the challenge of pitch,” Renewable Energy, vol. 36, no. 3, pp. 893-897, 2011.
P. Lap-Arparat and T. Leephakpreeda, “Real-time maximized power generation of vertical axis wind turbines based on characteristic curves of power coefficients via fuzzy pulse width modulation load regulation,” Energy, vol. 182, pp. 975-987, 2019.
C. Li, S. Zhu, Y. Xu, and Y. Xiao, “2.5D large eddy simulation of vertical axis wind turbine in consideration of high angle of attack flow,” Renewable Energy, vol. 51, pp. 317-330, 2013.
C. Li, Y. Xiao, Y.-I. Xu, Y.-x. Peng, G. Hu, and S. Zhu, “Optimization of blade pitch in h-rotor vertical axis wind turbines through computational fluid dynamics simulations,” Applied Energy, vol. 212, pp. 1107-1125, 2018.
L. Li, I. Chopra, W. Zhu, and M. Yu, “Performance analysis and optimization of a vertical-axis wind turbine with a high tip-speed ratio,” Energies, vol. 14, no. 4, 2021.
K. Liu, M. Yu, and W. Zhu, “Enhancing wind energy harvesting performance of vertical axis wind turbines with a new hybrid design: A fluid-structure interaction study,” Renewable Energy, vol. 140, pp. 912-927, 2019.
K. Liu, M. Yu, and W. Zhu, “Performance analysis of vertical axis water turbines under single-phase water and two-phase open channel flow conditions,” Ocean Engineering, vol. 238, p. 109769, 2021.
K. W. McLaren, A numerical and experimental study of unsteady loading of high solidity vertical axis wind turbines. MS Thesis, McMaster University, 2011.
I. Paraschivoiu, O. Trifu, and F. Saeed, “H-Darrieus wind turbine with blade pitch control,” International Journal of Rotating Machinery, vol. 2009, pp. 1-7, 2009.
A. Rezaeiha, H. Montazeri, and B. Blocken, “Towards optimal aerodynamic design of vertical axis wind turbines: Impact of solidity and number of blades,” Energy, vol. 165, pp. 1129-1148, 2018.
A. Rezaeiha, H. Montazeri, and B. Blocken, “On the accuracy of turbulence models for CFD simulations of vertical axis wind turbines,” Energy, vol. 180, pp. 838-857, 2019.
Y. Wang, X. Sun, X. Dong, B. Zhu, D. Huang, and Z. Zheng, “Numerical investigation on aerodynamic performance of a novel vertical axis wind turbine with adaptive blades,” Energy Conversion and Management, vol. 108, pp. 275-286, 2016.
K. S. Wisner, Improving Vertical Axis Turbine Performance with Active Blade Pitch Control: Mechanism Design and Fundamental Physics Analysis. MS Thesis, University of Maryland Baltimore County, Baltimore, Maryland, 2023.
Q. Xiao and Q. Zhu, “A review on flow energy harvesters based on flapping foils,” Journal of Fluids and Structures, vol. 46, pp. 174-191, 2014.
M. Yu, Z. Wang, and H. Hu, “High fidelity numerical simulation of airfoil thickness and kinematics effects on flapping airfoil propulsion,” Journal of Fluids and Structures, vol. 42, pp. 166-186, 2013.
Z. Zhao, D. Wang, T. Wang, W. Shen, H. Liu, and M. Chen, “A review: Approaches for aerodynamic performance improvement of lift-type vertical axis wind turbine,” Sustainable Energy Technologies and Assessments, vol. 49, p. 101789, 2022.

What is claimed is:

1. A method of enhancing the performance of a vertical axis turbine (VAT) comprising at least two turbine blades, said method comprising:
integrating blade pitch control with the VAT, wherein blade pitch for each blade is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric).

2. The method of claim 1, wherein the VAT comprises 2, 3, 4, 5 or 6 blades.

3. The method of claim 1, wherein the VAT comprises 3 blades.

4. The method of claim 1, wherein the VAT comprises a Darrieus-type rotor.

5. The method of claim 1, wherein the enhanced performance is manifested as an increase of time-averaged net power coefficient (C_{P}).

6. The method of claim 5, wherein the C_{P} is greater than about 0.45.

7. The method of claim 1, comprising a symmetric control scheme.

8. The method of claim 1, comprising an asymmetric control scheme.

9. The method of claim 1, wherein the VAT is capable of generating positive torque in both upstream and downstream cycles.

10. The method of claim 1, wherein the blade pitch control comprises a continuous function.

11. The method of claim 8, wherein the second constant AoA is greater than the first constant AoA.

12. The method of claim 1, wherein the VAT comprises an anemometer.

13. A vertical axis turbine (VAT) comprising:
at least two turbine blades;
at least two actuators, wherein each turbine blade has a dedicated actuator and wherein a blade pitch of each blade is independently adjustable by the dedicated actuator;
a shaft, wherein the at least two turbine blades are arranged to rotate about the shaft;
a base or pedestal to support the shaft;
an anemometer; and
a computer program product communicatively connected to each actuator and the anemometer, wherein the computer program product comprises a computer readable storage medium having program instructions embodied therewith, the program instructions executable by a computing device to cause the computing device to control the VAT to enhance the performance of the VAT by:
integrating blade pitch control with the VAT, wherein blade pitch is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric),
wherein the blade pitch of each blade is continuously adjusted using the actuators.

14. The method of claim 13, wherein the VAT comprises a Darrieus-type rotor.

15. The method of claim 13, comprising a symmetric control scheme.

16. The method of claim 13, comprising an asymmetric control scheme.

17. The method of claim 13, wherein the blade pitch control comprises a continuous function.

18. The method of claim 16, wherein the second constant AoA is greater than the first constant AoA.

19. A computer program product comprising a computer readable storage medium having program instructions embodied therewith, the program instructions executable by a computing device to cause the computing device to control a vertical axis turbine (VAT) comprising at least two turbine blades to enhance the performance of the VAT by:
integrating blade pitch control with the VAT, wherein blade pitch is continuously adjusted to maintain a constant angle of attack (AoA) for each blade, independently, during the entire 360° rotation (symmetric) or to maintain a first constant AoA for each blade in an upstream zone and a second constant AoA for each blade in a downstream zone (asymmetric),
wherein the blade pitch is continuously adjusted using actuators.

20. The computer program product of claim 19, wherein the VAT comprises an anemometer.
